(19) United States
(12) Patent Application Publication
(10) Pub. No.: US 2013/0201051 A1
(43) Pub. Date: Aug. 8, 2013

(54) VEHICULAR OBSERVATION AND DETECTION APPARATUS

(71) Applicant: ITERIS, INC., Santa Ana, CA (US)

(72) Inventors: TODD W. KRETER, IRVINE, CA (US); MICHAEL T. WHITING, RANCHO SANTA MARGARITA, CA (US); YAN GAO, PLACENTIA, CA (US); WILLIAM H. LEE, WESTMINSTER, CA (US); ROBERT PAUL DRAP, MISSION VIEJO, CA (US); CHANDRA SEKHAR GATLA, FOUNTAIN VALLEY, CA (US)

(73) Assignee: ITERIS, INC., SANTA ANA, CA (US)

(21) Appl. No.: 13/761,227

(22) Filed: Feb. 7, 2013

Related U.S. Application Data
(60) Provisional application No. 61/596,699, filed on Feb. 8, 2012.

(51) Int. Cl. G01S 13/86

(52) U.S. Cl. CPC G01S 13/867
USPC 342/52

(57) ABSTRACT

A vehicular observation and detection apparatus and system includes a radar sensor, a camera, and circuitry for packaging radar data and a video signal together, inside a housing. Additional processors determine information contained within the radar data and video signal and perform data processing operations on the information to conduct traffic management and control.

### CROSS-REFERENCE TO RELATED PATENT APPLICATIONS

This patent application claims priority to U.S. provisional application 61/596,699, filed on Feb. 8, 2012, the contents of which are incorporated in their entirety herein.

### FIELD OF THE INVENTION

The present invention relates generally to vehicular observation and detection. More specifically, particular embodiments of the invention relate to traffic control systems, and to methods of observing and detecting the presence and movement of vehicles in traffic environments using video and radar modules.

### BACKGROUND OF THE INVENTION

There are many conventional traffic detection systems. Conventional detectors utilize sensors, either in the roadway itself, or positioned at a roadside location or on traffic lights. The most common type of vehicular sensors are inductive coils, or loops, embedded in a road surface. Other existing systems utilize video, radar, or both, at either the side of a roadway or positioned higher above traffic to observe and detect vehicles in a desired area.

Systems that utilize both video and radar separately to detect vehicles in a desired area collect vehicular data using either a camera, in the case of video, or radio waves, in the case of conventional radar systems, to detect the presence of objects in an area. Because data from each detector varies greatly in the type of signal to be processed and the information contained therein, video and radar data can be difficult to process and utilize in traffic management. Additionally, it is difficult to integrate the different types of data to perform more sophisticated data analysis.

Detection is the key input to traffic management systems, but for the reasons noted above, data representative of vehicles in desired areas is separately collected and processed. While each set of data may be used to perform separate traffic control functions, there is presently no convenient and customizable way of processing both types of data together, or any method of integrating this data to perform functions that take traffic conditions in different zones of an area into account. There is therefore no present method of using radar data and video data together to determine and respond to traffic conditions in a wider range relative to the location of a particular traffic detection system.

Accordingly, there is a need for traffic detection systems that integrate data from different types of vehicle detection to enable robust, sophisticated traffic control. Public agencies, for example, have a strong need to manage traffic efficiently in a variety of different conditions and locations—at intersections, at mid-block and between intersections, in construction and other safety zones such as those for schools or where children are likely to be present, and on high-volume or high-speed thoroughfares such as highways. It is therefore one object of the present invention to provide products and software products to enable remote communications systems to integrate data for quick, multi-faceted data analysis in traffic control environments.

### BRIEF SUMMARY OF THE INVENTION

The present invention discloses a vehicular observation and detection apparatus and system, and method of performing traffic management in a traffic environment comprising one or more intended areas of observation. The vehicular observation and detection apparatus includes a radar sensor, a camera, a housing, and circuitry capable of performing signal processing from data generated by the radar sensor and the camera either alone or combination. Additional data processing modules are included to perform one or more operations on the data generated by the radar sensor and the camera. Methods of performing traffic management according to the present invention utilize this data to analyze traffic in a variety different situations and conditions.

The present invention provides numerous benefits and advantages over prior art and conventional traffic detection systems. For example, the present invention offers improvements in detection accuracy and customizable modules that allow for flexible and reconfigurable “zone” definition and placement. Additionally, the present invention is scalable to allow for growth and expansion of traffic environments over time. The present invention also provides customers with the ability to use data in variety of ways, including for example the use of video images for verification of timing change effectiveness and incident review. The present invention further allows for enhanced dilemma zone precision, extended range advanced detection, richer count, speed and occupancy data, and precise vehicle location and speed data for new safety applications, among many other uses. Safety, efficiency, and cost are also greatly enhanced, as installation of the present invention is much easier, less-expensive, and safer than with in-pavement systems.

Together, the radar sensor and camera enable the present invention to extend traffic detection up to at least 600 feet, or about 180 meters, from a traffic signal, and add range and precision for advanced detection situations such as with high speed approaches, for example when a vehicle enters a “dilemma” zone in which the driver must decide whether to stop or proceed through an intersection with a changing signal. The combined approach to detection and data analysis is also particularly useful in adverse weather conditions such as in heavy rain or fog. It also enhances video-based “stop bar” detection through sensor fusion algorithms that utilize both radar and video data. Together, the radar sensor and camera provide a much richer set of available data for traffic control, such as count, speed, occupancy, individual vehicle position, and speed.

The present invention also provides enhanced signal and traffic safety applications. As noted above, applications such as dilemma zone operation are greatly improved. Other safety applications of the present invention include intersection collision avoidance and corridor speed control with a “rest in red” approach. As noted above, the present invention also results in lower installation costs than in-pavement detection systems and improved installer safety, since there is no trenching or pavement cutting required.

In one embodiment of the present invention, a vehicular observation and detection apparatus comprises a camera sensor configured to capture video images in a first intended area in a traffic environment, a radar sensor configured to collect radar data in a second intended area in the traffic environment, a first signal processor configured to combine vehicular information included within the video images and vehicular information included within the radar data to analyze the traffic environment by at least identifying a vehicle's presence, speed, size, and position relative to the first and second identified areas for transmission to one or more modules configured to perform data processing functions based on the vehicular information, and a second signal processor configured to separate the video images from the radar data for performing the one or more data processing functions, identify a stop zone within the first intended area and identify an advanced detection zone within the second intended area, and optimize traffic signal controller functions, wherein a size of the stop zone and a size of the advanced detection zone, relative to the traffic signal in the traffic environment, varies based at least upon vehicular approach speed and intersection approach characteristics.

In another embodiment of the present invention, a method of performing traffic environment management comprises collecting video data representing at least one vehicle in a first intended area of a traffic environment using a camera sensor; generating a signal representative of the video data collected relative to the first intended area, the video data including image information relative to the at least one vehicle in the first intended area; collecting radar data representing at least one vehicle in a second intended area in the traffic environment using a radar sensor, the radar data including headers, footers, and vehicular information that includes at least an object number, an object position, and an object speed of the at least one vehicle in the second intended area; encoding the radar data into the signal representative of the video data to form a combined transmission of radar data and video data to a processor comprising a plurality of data processing modules; separating the radar data from the video data to process the image information relative to the at least one vehicle in the first intended area in a video detection module among the data processing modules, and to process the vehicular information that includes at least an object number, an object position, and an object speed of the at least one vehicle in the second intended area in a radar detection module among the data processing modules; adjusting zonal trigger points identifying the first and second intended areas based on image information processed in the video detection module and vehicular information processed in the radar detection module; and performing one or more functions of a traffic signal controller from data generated by the video detection module and the radar detection module to manage the traffic environment.

In yet another embodiment of the present invention, a vehicular observation and detection apparatus comprises a camera positioned proximate to a traffic environment to be analyzed, the camera configured to generate a video signal indicative of a presence of vehicular activity in an intended area, a radar apparatus positioned proximate to the traffic environment to be analyzed, the radar apparatus configured to generate radar data indicative of a presence of vehicular activity in the intended area and comprising at least an object number, an object speed, and an object position representative of at least one vehicle, wherein the intended area comprises a stop zone and one or more advanced detection zones, the camera monitoring vehicular activity in the stop zone, and the radar apparatus monitoring vehicular activity in the one or more advanced detection zones, an interface coupled to the radar apparatus and to the camera, configured to encode the radar data received from the radar sensor for transmission by retaining data representing a set number of vehicles from the radar data for a specific period of time and combining encoded radar data with the video signal for the specific period of time, and a detection processor configured to receive the video signal including the encoded radar data, separate the encoded radar data from the video signal, store the radar data in a local memory at the detection processor, and perform one or more operative processing functions on the radar data and the video signal that combine information generated by both the radar apparatus and the camera to identify the stop zone and the one or more advanced detection zones, and adjust one or more traffic signal controller functions to manage traffic the traffic environment.

Other embodiments, features and advantages of the present invention will become apparent from the following description of the embodiments, taken together with the accompanying drawings, which illustrate, by way of example, the principles of the invention.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a block diagram overview of a vehicular observation and detection apparatus according to the present invention;

FIG. 2 is a block diagram of system components in a vehicular observation and detection apparatus according to the present invention;

FIG. 3 is a diagram of example stop zone and advanced detection zones in a traffic environment for which vehicular activity is analyzed according to one embodiment of the present invention;

FIG. 4 is an exemplary diagram of zones in a traffic environment indicating location and speed threshold for signal control where there is a potential of a vehicle running a red light, according to another embodiment of the present invention;

FIG. 5 is a plot of distance and speed indicating dilemma zone considerations in signal control according to the embodiment of FIG. 4; and

FIG. 6 is a further plot of distance over speed indicating outputs for a signal controller according to the embodiment of FIG. 4.

### DETAILED DESCRIPTION OF THE INVENTION

In the following description of the present invention reference is made to the accompanying figures which form a part thereof, and in which is shown, by way of illustration, exemplary embodiments illustrating the principles of the present invention and how it is practiced. Other embodiments will be utilized to practice the present invention and structural and functional changes will be made thereto without departing from the scope of the present invention.

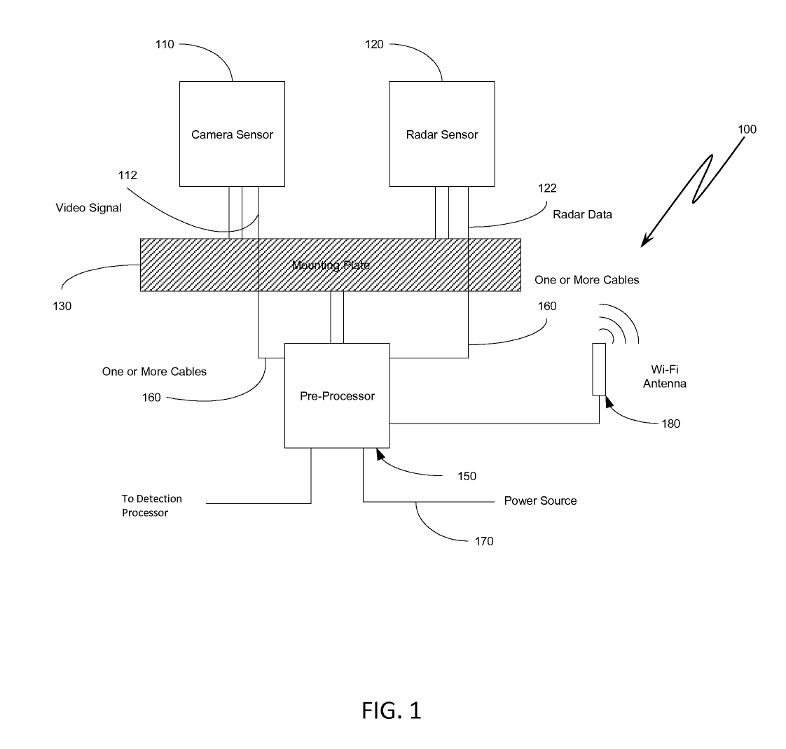

FIG. 1 is a block diagram overview of components in a vehicular observation and detection apparatus 100 according to the present invention. The vehicular observation and detection apparatus 100 includes a camera sensor 110, capable of generating a video signal 112, and a radar sensor 120, capable of generating radar data 122. Each of the video signal 112 and the radar data 122 contain information representative of one or more vehicles either in or approaching definable zones in an intended traffic area comprising a traffic environment. The camera sensor 110 and the radar sensor 120 are coupled to a mounting plate 130 and disposed within a housing 140 (not shown), which is mountable on a traffic light, a pole or arm connecting a traffic light to a traffic light pole, the traffic pole itself, or on its own pole. The housing 140 also includes circuitry and other hardware, such as one or more processors 150, for processing and transmitting the video signal 112 and the radar data 122 as discussed further herein to perform a variety of different data processing and communications tasks.

The housing 140 includes at least one aperture through which the camera sensor 110 is directed at one or more intended areas of detection in the traffic environment. The radar sensor 120 includes a transmitter and receiver, also included within the housing 140, which are generally configured so that radio waves or microwaves are directed to the one or more intended areas of detection. In the present invention, the camera sensor 110 is configured to detect vehicular activity in a first zone within the one or more intended areas, and the radar sensor 120 is configured to detect vehicular activity in a second zone within the one or more intended areas.

At a rear portion of the vehicular observation and detection apparatus 100 is a separate attachment housing configured to allow the vehicular observation and detection apparatus 100 to be mounted as described above. A plurality of ports are included to permit data to be transmitted to and from the vehicular observation and detection apparatus 100 via one or more cables 160. At least one of the ports is provided for a power source 170 for the vehicular observation and detection apparatus 100. The vehicular observation and detection apparatus 100 may also include other components, such as an antenna 180 for wireless or radio transmission and reception of data.

The vehicular observation and detection apparatus 100 is intended to be mounted on or near a traffic signal, at a position above a roadway's surface and proximate to a traffic intersection within a traffic environment to be analyzed, to enable optimum angles and views for detecting vehicles in the one or more intended areas with both the camera sensor 110 and the radar sensor 120.

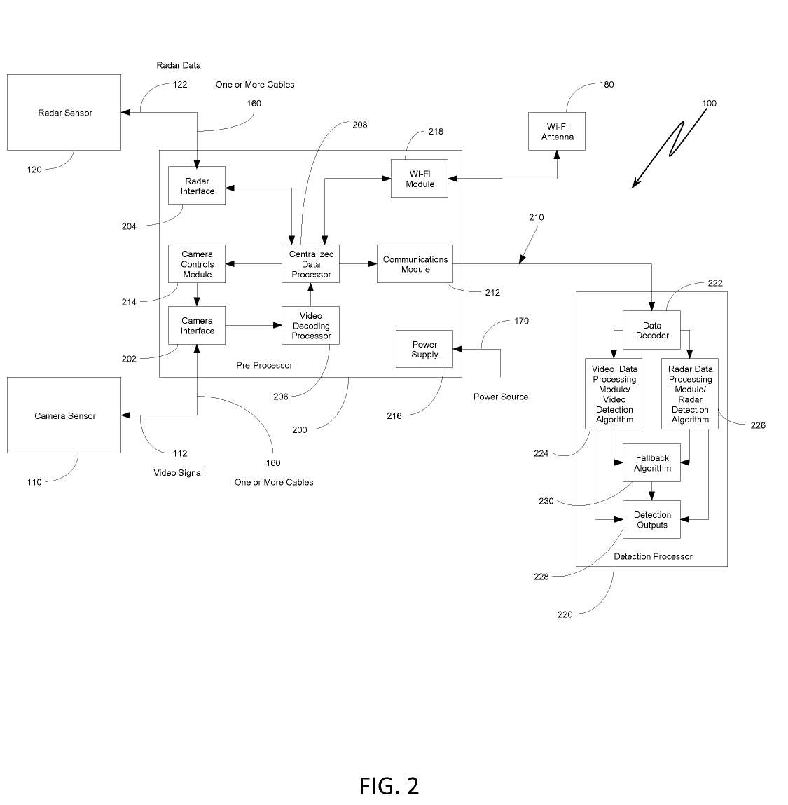

FIG. 2 is a further block diagram indicating details of particular system components in the vehicular observation and detection apparatus 100. The camera sensor 110 and the radar sensor 120 are separate components within the housing 140 that each independently detect particular zones of the one or more intended areas proximate to an intersection. As noted above, the present invention also includes a plurality of processors 150 capable of performing one or more data processing functions. One such processor 150 is a pre-processor 200 positioned inside the housing 140, and a detection processor 220 at an outside or distant location such as in a traffic signal controller contained within a cabinet. The detection processor 220 at the external (to the housing 140) traffic signal controller of the present invention is part of a traffic signal control system that utilizes data from the camera sensor 110 and the radar sensor 120 to determine operation of one or more traffic signals in the area in which the vehicular observation and detection apparatus 100 operates.

The pre-processor 200 includes a plurality of hardware components and data processing modules configured to prepare the video data 112 and the radar data 122 for further analysis at the detection processor 220. The pre-processor 200 may, in one embodiment, include interfaces coupled to each of the camera sensor 110 and the radar sensor 120 via cables 160 over which power, radar data 122, video signal 112, and a camera control signal are transmitted. These interfaces include a camera sensor interface 202 and a radar sensor interface 204. Output data from the camera sensor interface 202 is first transmitted to a video decoding processor 206, and then to a centralized data processor 208, which combines the output of the video decoding processor 206 with the radar data 122 communicated by the radar sensor interface 204. The centralized data processor 208 may be considered an encoder configured to embed the radar data 122 in portions of the video signal 112. The centralized data processor 208 generates output data comprised of encoded video and radar data 210, together with additional information, and communicates this combined, encoded video and radar data 210 via communications module 212 for further analysis by the detection processor 220. The centralized data processor 208 is also coupled to a camera controls module 214 configured to adjust the camera sensor 110 where the centralized data processor 208 determines from the content of the images in the video signal 112 that the camera 110 not properly detecting information from the intended area to which it is configured to observe.

The pre-processor 200 as indicated in FIG. 2 also includes a power supply 216 for powering the components therein from the power source 170, and to the detection processor 210 via the one or more cables 160, over which radar data 122 is transmitted together with the video signal 112 as generated by the centralized data processor 208. The pre-processor 200 may also be coupled to a Wi-Fi module 218, through which one or more wireless setup and analysis tools may be utilized via the antenna 180.

The detection processor 220 may perform one or more tasks relative to the data received in the outgoing signal combining video data 112 and radar data 122 from the communications module 212 of the pre-processor 200. For example, the detection processor 220 may perform radar data parsing to separate the radar data 122 from the video signal 112 and determine the presence and movement of vehicles in a zone targeted by the radar sensor 120. The detection processor 210 may also perform video processing on the video data 112 in the signal received from the pre-processor 200 to determine the presence and movement of vehicles in a zone targeted by the camera sensor 110. Fusion of the information contained within the video data 112 and the radar data 122 may also be performed by the detection processor 220.

The detection processor 220 also includes a plurality of hardware components and data processing modules configured to analyze the video data 112 and the radar data 122. A data decoder 222 decodes the incoming signal communicated by the communications module 212 of the pre-processor 200, and initiates modules to begin processing the received data. These at least include a video data processing module 224 and the radar data processing module 226. Each of these modules performs one or more processing functions executed by a plurality of program instructions either embedded therein or called from additional processing modules to analyze vehicular activity within the traffic environment. The video data processing module 224 and the radar data processing module 226 then generate detection outputs 228.

One example of the one or more data processing functions performed by the video data processing module 224 and the radar data processing module 226 is a fallback algorithm 230. The fallback algorithm 230, discussed further herein, determines whether the quality of the data in the video signal 112 is sufficient for analysis by the detection processor 220, and if not, initiates a fallback procedure to rely on radar data 122 for further processing.

Detection outputs 228 are output data that is representative of the one or more data processing functions performed by the video detection algorithm 222 and the radar detection algorithm 224. The data processing functions include, but are not limited to, stop zone and advanced detection zone processing, and “dilemma” zone processing, each discussed further herein. Detection outputs 228 may also be considered as instructions, contained in one or more signals, to be communicated to a traffic signal controller to perform a plurality of traffic signal functions, such as for example modifying signal timing based on vehicular information collected by the camera 110 and the radar sensor 120.

As noted above, radar data 122 representative of vehicular information such as presence and movement in one zone of at least one intended area is generated by the radar sensor 120 and transmitted from the radar sensor 120 to the pre-processor 200. This transmission of radar data 122 occurs periodically, such as for example every 50 ms. The radar data 122 includes headers and footers to delimit data packets and separate raw data for up to 64 objects that are generally representative of vehicles detected. Vehicular information in the radar data 122 may include an object number, an object speed, and an object position. The pre-processor 200 includes a module that strips the header and footer and retains only the radar data 122 for a set number of objects, for example the first 30 objects. This radar data 122 is then repackaged to be communicated to the detection processor 210 in the traffic control cabinet.

Video data 112 representative of vehicular information is generated by the camera sensor 110. The video data 112 is contained in a signal sent by the camera sensor 112 to the pre-processor 200 via the video data interface 202. Repackaged radar data 122 as discussed above is then encoded along with the video data 112 on a single cable, and may include multiple conductors. This encoded radar data and video data is then transmitted to the detection processor 220 via the communications module 212. The combined data may include additional information, such as for example error correction information to ensure data integrity between the pre-processor 200 and the detection processor 220.

In one embodiment, repackaged radar data 122 is encoded on hidden data lines in the video signal 112, such as for example TV lines. The present invention may use hidden TV lines such as those reserved for the Teletext system to embed the radar data 122 in the video signal 112. Teletext is an industry standard for data transmission on TV lines which includes error correction.

The combined data is then transmitted to the detection processor 220. This may be accomplished using standard transmission across cable. The detection processor 220 separates the radar data 122 from the video signal 112 and stores it in local memory. The video signal 112 and the radar data 122 are then processed by various algorithms designed to process such data both individually and together.

Contents of the video signal 112 are processed by the video detection algorithm 222, and the contents of the radar data 122 is processed by a separate radar detection algorithm 224 at the detection processor 220 that compares position of objects within certain zonal trigger points, which are initially defined by and set by the user and form different areas of the overall intended area in a traffic environment to be targeted by the radar sensor. If an object enters such a zonal trigger point, an associated output will be activated. If no objects are determined to be in the zone of the trigger point then the output will be off. The outputs associated with these zonal trigger points are determined by the user. This function of radar data processing is similar to the presence-type zone data analysis in the video detection algorithm 222. These types of zonal analyses provide the traffic signal controller with vehicular information needed to perform traffic management.

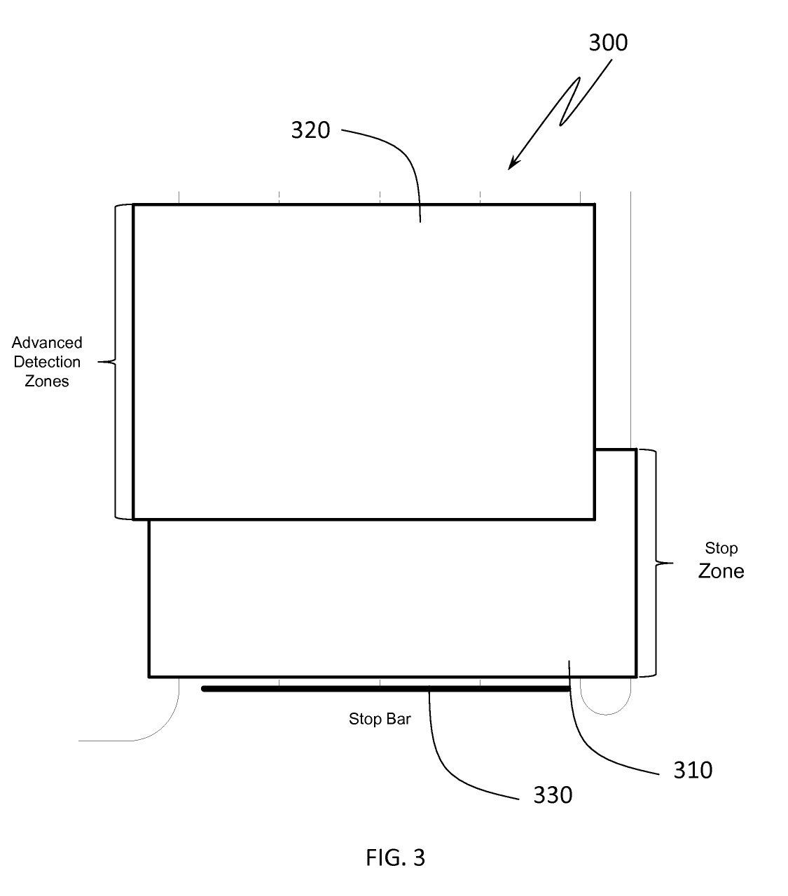

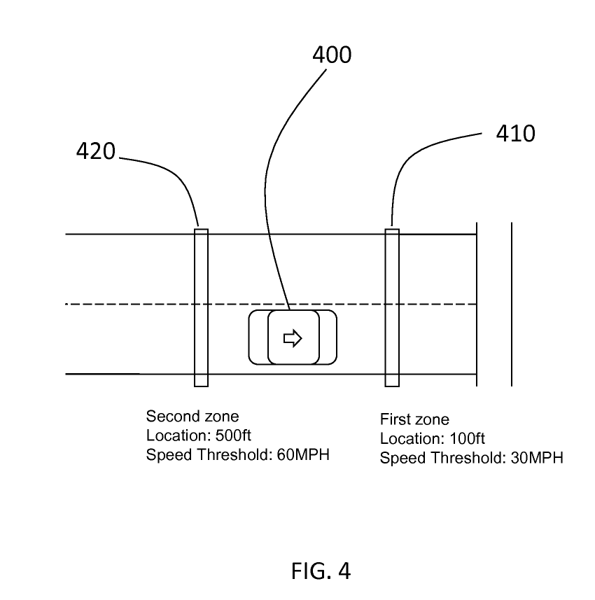

In addition to providing the traffic signal controller with vehicular detection information, certain radar sensor zonal trigger points (such as for example the one determined to be nearest a stop bar 330, shown in FIG. 3) may also be used for data collection. FIG. 3 and FIG. 4 are diagrams showing detection paradigms using zonal trigger points in a traffic environment 300. FIG. 3 is a diagram of a stop zone 310 and advanced detection zones 320 in a traffic environment 300 for which vehicular activity is analyzed according to one embodiment of the present invention.

The radar detection algorithm 224 allows zone-type data processing to perform multiple functions. Data of the type generated at zonal trigger points is known as CSO—Count Speed Occupancy. The information collected therefore includes a count (the number of vehicles 340 passing through the zone), speed (the average speed of vehicles 340 passing through the zone for the selected ‘bin interval’), and occupancy (the % of time the roadway is occupied by vehicles during the ‘bin interval’). The CSO data is stored in memory locations known as “bins.” A bin interval is determined by the user and can be set in fixed time increments, such as for example from between 10 seconds and 60 minutes.

FIG. 3 is a representation of zones of an intended area in a traffic environment 300 covered by both a camera sensor 110 and a radar sensor 120 in a vehicular observation and detection apparatus 100. In FIG. 3, a radar sensor 120 detects the presence or movement of vehicles 340 at a certain distance away from the location of the vehicular observation and detection apparatus 100, such as for example between 200 ft (about 60 meters) and 600 ft (about 180 meters) away. This area forms a first zone, comprised of advanced detection zones 320, with an intended area of a traffic environment 300. The camera sensor 110 detects the presence or movement of vehicles 340 at a certain shorter distance away from the location of the vehicular detection apparatus 100, such as for example between 0 ft (or 0 meters) and 300 ft (about 90 meters) away. This area forms second zone, comprised of the stop zone 310 proximate to the stop bar 330, with the intended area of the traffic environment 300. Together, the two types of detection systems 110 and 120 can cover a longer range from the vehicular observation and detection apparatus 100, and therefore provide a much higher level of accuracy and also a greater amount of information for data processing by the detection processor at the traffic signal controller.

In a typical application of the present invention, at least one vehicle detection apparatus is placed at locations proximate to traffic intersections to monitor and control traffic in such areas. The combination of both radar sensors and camera sensors offers a greater range of detection, enabling more sophisticated data analysis and ultimately safer and more consistent traffic conditions to allow for an appropriate flow of vehicles. Multiple vehicular observation and detection apparatuses 100 may be deployed at the same traffic intersection, and may be placed at different positions in the same traffic environment 300 to enhance the quality of data gathered.

It should be understood that any number of vehicular observation and detection apparatuses 100 may be utilized to perform traffic control and management within the present invention. Where multiple apparatuses are used to control traffic, for example in a particular intersection, each vehicular observation and detection apparatus 100 may be coupled to the same detection processor and traffic signal controller. Alternatively, each may be coupled to its own detection processor 220, and the traffic signal controller may receive data from each detection processor 220. Regardless, the vehicular observation and detection apparatus 100 of the present invention offers vast improvement over conventional in-pavement systems that rely solely on counters or inductive loops to indicate when vehicles may be present in a particular area.

FIG. 3 therefore depicts one such application in which the vehicular observation and detection apparatus 100 enables more sophisticated data processing using combined video data 112 and radar data 122. At any approach to a traffic environment 300, such as an intersection, certain areas may be defined to optimize traffic controller functions. For example, the area at or around the stop bar or line 330, or the position where traffic will stop when the signal is red, extends from the stop line itself to a distance approximately 300′ (about 90 meters) behind the stop line 330 to form the stop zone 310. The area from approximately 200′ (about 60 meters) behind the stop line to approximately 600′ (about 180 meters) behind may be considered the advanced detection area 320. This area 320 will be determined on an approach be approach basis and is defined by many factors, including but not limited to vehicular approach speed and position relative to the intersection, an approach gradient and curve, buildings and building types at or around the intersection and pedestrian traffic volume.

Another application of data processing using combined radar data and video data in a vehicular observation and detection apparatus 100 according to the present invention is a fallback on radar information where no video signal exists, or no data is contained within such signal. Such data processing is performed, as noted above, by the fallback algorithm 230 at the detection processor 220. The video data processing module 224, which performs the video data processing functionality from the video signal 112, includes hardware confirmation that a video signal 112 is present, via a video sync pulse. As a first step in determining whether fallback is to be deployed, the present invention determines whether such a video sync pulse indicates the presence of a video signal 112.

The presence of this video sync pulse, however, does not confirm that the image the algorithm is processing contains field of view information. There are a number of reasons why there is no image in the video signal 112 for the video detection algorithm 224 to process. For example, partial failure of the camera module; imager sensor 110 failure while still generating a sync pulse; environmental conditions, such as fog, ice or dirt that obscure or block the image taken by the camera sensor 110; and other conditions, animals or objects that partially or totally obscure the image.

The video data processing module 224 and the radar data processing module 226 of the detection processor 220 constantly monitor both the video and radar and sensors 110 and 120 for vehicle detection. It is expected in a fully functioning system that at some time after the radar sensor 120 detects a vehicle 340 that one or more of the zones monitored by the camera sensor 110 will also detect a vehicle 340. If the radar sensor 120 is detecting vehicles but the video algorithm 224 indicates that the camera sensor 110 is not, the system assumes that a problem as described above must have occurred with the image in the video signal 112. When this situation is identified, a “Radar Constant Call” is initiated by the vehicular observation and detection apparatus 100. In this mode, the radar sensor 120 is commanded to “look” at an area that is approximately from the intersection stop line 330 to 20 meters back. If the radar sensor 120 identifies that a vehicle 340 is present, the system activates all video detection zones. When no vehicle 340 is detected by the radar sensor 120 then all the video zones are deactivated.

The fallback algorithm 230 then continues to monitor the situation. When the video algorithm in the video data processing module 224 begins to indicate detection of vehicles 340, the “Radar Constant Call” is cancelled and normal operation is resumed.

Yet another application of data processing using combined radar data and video data in a vehicular observation and detection apparatus according to the present invention is a dynamic “dilemma” zone approach that performs continuous determination of safe or unsafe passage. FIG. 4 is an exemplary diagram of zones in a traffic environment 300 indicating location and speed threshold for signal control where there is a potential of a vehicle running a red light, according to this “dilemma” zone approach.

The “dilemma” zone in traffic environments 300 is the area in which, when a traffic light turns amber, motorists make different decisions about whether to advance through a traffic signal or to stop. Decisions made in this area can result in red light running and potential T-bone crashes as well as sudden stops which can result in rear end collisions.

The multiple detection means of the present invention allow at least two locations to be identified, and vehicles are analyzed as they pass these locations, or zones. FIG. 4 shows two such zones, a first zone 410 and a second zone 420. The present invention establishes speed thresholds at each of these zones 410 and 420. If a vehicle 340 is travelling faster than the speed threshold, a warning as an output signal is sent to the traffic signal controller. This signal controller can be programmed in response to the output signal to change the signal timing to allow the safe passage of the vehicle 340. This timing extension can be done in many ways, either by extending the green phase for the subject vehicle 340, extending the yellow phase for the subject vehicle 340, or holding the opposing cross street red signals so that the high speed subject vehicle passes through the red phase but no opposing traffic passes. Extending the green or yellow can “reward” the behavior of high speed motorists, so in such an implementation a red light running enforcement system may be deployed in conjunction with holding opposing reds to act as deterrent to such behavior.

This dilemma zone embodiment defines a different and improved way to indicate to the signal controller that there is a potential of a vehicle running a red light. The determination of whether such potential exists is defined throughout a vehicle's progress in its approach to an intersection of the traffic environment 300 by looking at a vehicle's speed and distance continuously and applying this combination to a calculated continuous threshold.

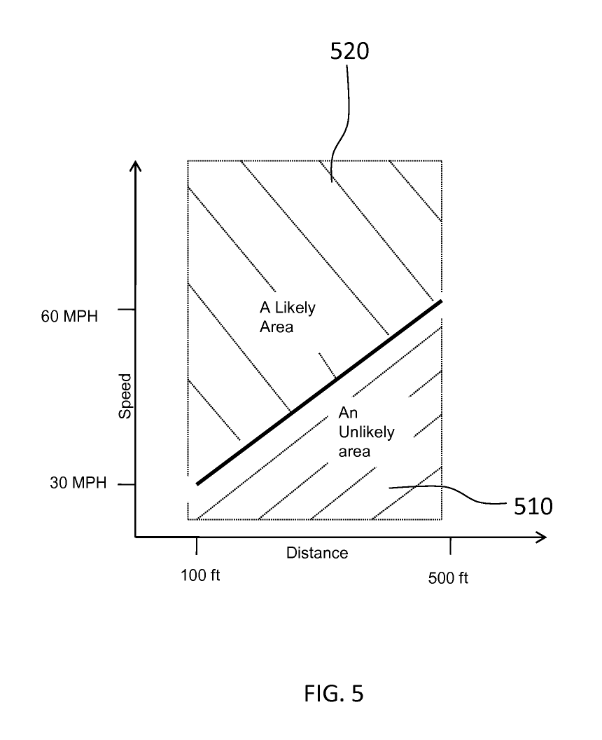

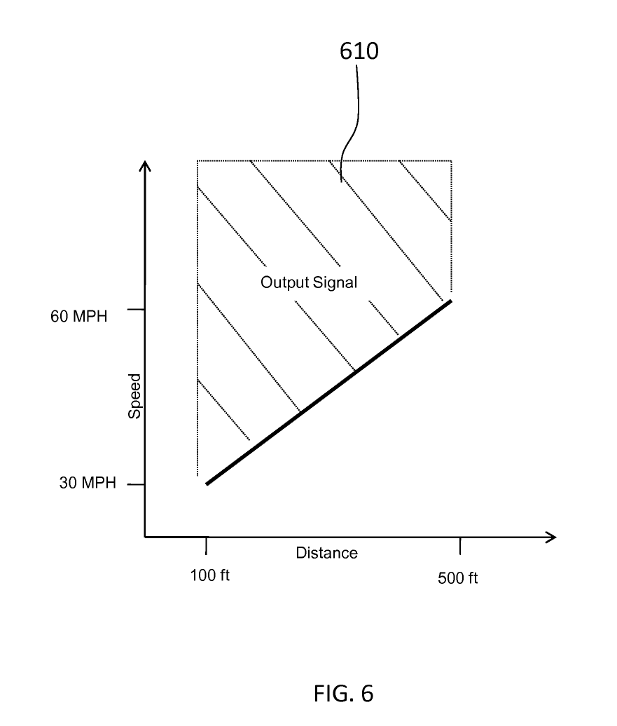

FIG. 5 is a plot of distance and speed indicating dilemma zone considerations in signal control, and FIG. 6 is a further plot of distance over speed indicating outputs for a signal controller according to this embodiment of the present invention. Areas of likely and unlikely to run a red light, indicated in FIG. 5 as an unlikely area 510 and a likely area 520, are calculated by the detection processor 220 and an output signal 610 is sent to the traffic signal controller to modify the signal timing in order to provide a safer traffic situation where one or more vehicles 340 are detected in an area relative to the calculated likely area 520. To configure this type of data processing, a user sets parameters at multiple points. At the first zone 410, the user sets a desired near distance for the location of the start of the area of coverage and a speed threshold. At the second zone 420, the user sets a desired far distance for the location of the end of the area of coverage and a speed threshold at that point. From this information the video and radar detection algorithms 224 and 226 calculate a dynamic threshold throughout the area of coverage.

The present invention may also include a wireless setup tool that allows users to remotely configure the radar sensor 120, the camera sensor 110, or the data processing to be performed. The user may therefore focus attention on particular types of data generated for particular applications or traffic conditions. The Wi-fi setup tool also offers customizable and easy-to-use graphical user interfaces for users to quickly configure the present invention to their needs. Users may therefore access the Wi-fi setup tool and configure the vehicular observation and detection apparatus 100 from any location, and from any type of device, including but not limited to a desktop computer, laptop computer, tablet device, or other mobile device.

It is to be understood that other embodiments will be utilized and structural and functional changes will be made without departing from the scope of the present invention. The foregoing descriptions of embodiments of the present invention have been presented for the purposes of illustration and description. It is not intended to be exhaustive or to limit the invention to the precise forms disclosed. Accordingly, many modifications and variations are possible in light of the above teachings. It is therefore intended that the scope of the invention be limited not by this detailed description.

1. A vehicular observation and detection apparatus, comprising:
a camera sensor configured to capture video images in a first intended area in a traffic environment;
a radar sensor configured to collect radar data in a second intended area in the traffic environment;
a first signal processor configured to combine vehicular information included within the video images and vehicular information included within the radar data to analyze the traffic environment by at least identifying a vehicle's presence, speed, size, and position relative to the first and second identified areas for transmission to one or more modules configured to perform data processing functions based on the vehicular information; and
a second signal processor configured to separate the video images from the radar data for performing the one or more data processing functions, identify a stop zone within the first intended area and identify an advanced detection zone within the second intended area, and optimize traffic signal controller functions,
wherein a size of the stop zone and a size of the advanced detection zone, relative to the traffic signal in the traffic environment, varies based at least upon vehicular approach speed and intersection approach characteristics.

2. The apparatus of claim 1, wherein the traffic environment is an intersection proximate to the traffic signal controller.

3. The apparatus of claim 2, wherein the intersection approach characteristics include at least one of a roadway gradient, a roadway curve, a presence of buildings proximate to the intersection, and pedestrian traffic volume at or near the intersection.

4. The apparatus of claim 1, wherein first signal processor is a pre-processor that includes one or more interfaces coupling each of the camera sensor and the radar sensor to circuitry configured to package the video images decoded by a video decoding module and the radar data together for transmission to the second signal processor.

5. The apparatus of claim 1, wherein the second signal processor is a detection processor that includes the one or more modules configured to perform data processing functions based on the vehicular information, the one or more modules including a video data processing module and a radar data processing module.

6. The apparatus of claim 5, wherein the detection processor is located at the traffic signal controller remote from a housing, the housing mounted proximate to the traffic signal and including the camera sensor, the radar sensor, and the first signal processor.

7. The apparatus of claim 1, further comprising a plurality of modules accessed by at least one of the first and second signal processors, and configured to integrate vehicular information from the video images and vehicular information from the radar data to analyze the traffic environment.

8. The apparatus of claim 4, wherein the first signal processor combines vehicular information included within the video images and vehicular information included within the radar data by encoding the radar data on hidden data lines in a video signal containing the video images.

9. The apparatus of claim 1, further comprising a wireless antenna and a wireless module permitting remote configuration of the radar sensor and the camera sensor, and remote manipulation of the one or more data processing functions.

10. A method of performing traffic environment management, comprising:
collecting video data representing at least one vehicle in a first intended area of a traffic environment using a camera sensor;
generating a signal representative of the video data collected relative to the first intended area, the video data including image information relative to the at least one vehicle in the first intended area;
collecting radar data representing at least one vehicle in a second intended area in the traffic environment using a radar sensor, the radar data including headers, footers, and vehicular information that includes at least an object number, an object position, and an object speed of the at least one vehicle in the second intended area;
encoding the radar data into the signal representative of the video data to form a combined transmission of radar data and video data to a processor comprising a plurality of data processing modules;
separating the radar data from the video data to process the image information relative to the at least one vehicle in the first intended area in a video detection module among the data processing modules, and to process the vehicular information that includes at least an object number, an object position, and an object speed of the at least one vehicle in the second intended area in a radar detection module among the data processing modules;
adjusting zonal trigger points identifying the first and second intended areas based on image information processed in the video detection module and vehicular information processed in the radar detection module; and
performing one or more functions of a traffic signal controller from data generated by the video detection module and the radar detection module to manage the traffic environment.

11. The method of claim 10, wherein the traffic environment is an intersection proximate to the traffic signal controller.

12. The method of claim 10, wherein the adjusting zonal trigger points identifying the first and second intended areas further comprises identifying a stop zone proximate to a traffic signal in the traffic environment, the stop zone forming the first intended area.

13. The method of claim 11, wherein the adjusting zonal trigger points identifying the first and second intended areas further comprises identifying at least one advanced detection zone distant from the traffic signal in the traffic environment, the at least one advanced detection zone forming the second intended area.

14. The method of claim 11, further comprising monitoring the at least one vehicle's progress in its approach to the intersection by continuously calculating speed thresholds and distances between the zonal trigger points.

15. The method of claim 14, wherein the performing one or more functions of a traffic signal controller further comprises modifying traffic signal timing where at least one vehicle exceeds a speed threshold relative to at least one of the zonal trigger points.

16. A vehicular observation and detection apparatus comprising:
a camera positioned proximate to a traffic environment to be analyzed, the camera configured to generate a video signal indicative of a presence of vehicular activity in an intended area;
a radar apparatus positioned proximate to the traffic environment to be analyzed, the radar apparatus configured to generate radar data indicative of a presence of vehicular activity in the intended area and comprising at least an object number, an object speed, and an object position representative of at least one vehicle,
wherein the intended area comprises a stop zone and one or more advanced detection zones, the camera monitoring vehicular activity in the stop zone, and the radar apparatus monitoring vehicular activity in the one or more advanced detection zones;
an interface coupled to the radar apparatus and to the camera, configured to encode the radar data received from the radar sensor for transmission by retaining data representing a set number of vehicles from the radar data for a specific period of time and combining encoded radar data with the video signal for the specific period of time; and
a detection processor configured to receive the video signal including the encoded radar data, separate the encoded radar data from the video signal, store the radar data in a local memory at the detection processor, and perform one or more operative processing functions on the radar data and the video signal that combine information generated by both the radar apparatus and the camera to identify the stop zone and the one or more advanced detection zones, and adjust one or more traffic signal controller functions to manage traffic the traffic environment.

17. The apparatus of claim 16, wherein the interface includes a radar interface coupling the radar apparatus to circuitry for encoding the radar data with the video signal, and further includes a camera interface coupling the camera to circuitry configured to decode video data from images included within the video signal prior to combining the video signal with the encoded radar data.

18. The apparatus of claim 16, wherein the detection processor comprises a plurality of modules that perform the one or more operative processing functions, the plurality of modules including a radar fallback module configured to manage traffic signal functions where the detection processor determines that video images taken by the camera are obscured.

19. The apparatus of claim 16, wherein the detection processor comprises a plurality of modules that perform the one or more operative processing functions, the plurality of modules including a dilemma zone module configured to modify signal timing where a speed thresholds at a zonal trigger point comprising one or more of the stop zone and the advanced detection zone is exceeded.

20. The apparatus of claim 16, wherein the traffic environment is an intersection proximate to a traffic signal, and wherein the camera, radar apparatus, and interface mounted within a housing in which the camera, the radar apparatus, and the interface are configured.

21. The apparatus of claim 20, wherein the detection processor is located at the traffic signal controller at a location distant from the housing.

22. The apparatus of claim 16, further comprising a wireless antenna and a wireless module permitting remote configuration of the radar apparatus and the camera, and remote manipulation of the one or more operative processing functions.
